(19) United States
(12) Patent Application Publication
(10) Pub. No.: US 2007/0185767 A1
(43) Pub. Date: Aug. 9, 2007

(54) Apparatus and methods of advertising utilizing photographic printer services

(75) Inventor: Richard P. Mottla, Escondido, CA (US)

Correspondence Address: STETINA BRUNDA GARRED & BRUCKER, 75 ENTERPRISE, SUITE 250, ALISO VIEJO, CA, 92656, US

(73) Assignee: Card-Mott Corporation

(21) Appl. No.: 11/350,354

(22) Filed: Feb. 8, 2006

(51) Int. Cl. G06Q 30/00

(52) U.S. Cl. 705/14

(57) ABSTRACT

A method for printing on a photographic print including a step of receiving advertising data from an advertiser. The method further includes receiving image data from a customer. The method further includes combining the advertising data and the image data into coupled data. The method further includes printing a photographic print, the photographic print including a photographic paper stock including an image section and an advertising section. The photographic print further includes a printed advertising indicia printed within the advertising section. The printed advertising indicia is based upon the advertising data in the coupled data. The photographic print further includes a printed image printed within the image section. The printed image is based upon the image data found in the coupled data. There is also provided a method for advertising from an advertiser perspective, a photographic print, and a printer according to other aspects of the invention.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to methods of and a device for printing and advertising utilizing photographic print services, and more particularly to methods of and a device for advertising which are coupled with processing photographic images for end customers.

With the advent of digital video recorders and other technologies which enable television viewers to skip over or avoid altogether commercial advertising on television, it has become increasingly more difficult for advertisers to reach their target audience. A further disincentive for television advertising is prompted by a drop in television viewership, and an aversion by the remaining viewers to the ever-increasing number of advertising spots on television. These negative trends in advertising are not limited to the television medium, but are also present in newspaper and periodical advertising, and on-line advertisers are finding it increasingly difficult to compete with pop-up and banner ads. In short, investment dollars spent on traditional methods of advertising are producing diminishing returns.

The widespread use of digital cameras and home printing devices has also resulted in a substantial reduction in the cost of retail photographic prints. As a result, retail photographic print services have experienced a precipitous drop in their profit margins, with many being at or near “break even” for the processing of standard 4×6 prints. Understandably, all retail photo printer services would presumably be interested in an opportunity to entice their customers away from home printing devices and back to their processing outlets.

Currently, photographic printer services charge customers for the development of their photographic images, processed from either traditional film or digital media. This business model barely covers the costs of material and labor associated with the printing of photographic prints by these printer services. However, an increase in the volume of photographic prints processed by the retail printer service for customers would reduce per print material and labor costs. Furthermore, a business method which shifts the payment for the material and labor costs associated with processing photographic prints from the customer to the advertiser would enable retail photo printer services to achieve economies of scale, while at the same time incentivising customers to use the services of the photo processing retailer at little or perhaps no cost.

Consequently, advertisers, retail printer services, and consumers could all benefit from an innovative alternative to the current advertising model.

Accordingly, there is a need in the art for improved methods and a device for advertising which utilizes photographic printer services as a way to reach consumers.

### BRIEF SUMMARY

According to an aspect of the present invention, there is provided a method for printing on a photographic print. The method includes a step of receiving advertising data from an advertiser. The method further includes a step of receiving image data from a customer. The method also includes a step of combining the advertising data and the image data into coupled data, which may be stored either as a designated permanent computer file or in a computer's temporary data storage location, commonly referred to as Random Access Memory (RAM). Finally, the method includes a step of printing a photographic print. The photographic print includes a photographic paper stock including an image section and an advertising section. The photographic print further includes a printed advertising indicia printed within the advertising section. The printed advertising indicia is based upon the advertising data found in the coupled data. The photographic print further includes a printed image printed within the image section. The printed image is based upon the image data found in the coupled data.

This method for printing is innovative in its coupling of advertising data with a customer's image data. Accordingly, the printing method described may serve the purpose of enabling a photographic print to serve as an advertising medium.

According to various embodiments of the present invention, the method for printing may have the advertiser print the photographic print. According to another embodiment, the method for printing may not have the advertiser print the photographic print. The advertising data may be received in electronic form. The image data may be received in the form of negatives. The image data may be received in electronic form. The image data may be received via a computer network. The method for printing may include a further step of charging a fee to the advertiser for inclusion of the printed advertising indicia in the photographic print. The photographic print may be paid for by the advertiser. The customer may not be charged for the photographic print.

According to another embodiment of the present invention, prior to combining advertising data and image data into coupled data, the method for printing may include a further step of offering to the customer printer services of the image data with a first pricing level for printing including printed advertising indicia and a second pricing level for printing not including printed advertising indicia. The method for printing may call for a first pricing level to the customer that is less than the second pricing level. The first pricing level may be at no charge to the customer.

According to another aspect of the present invention, there is provided a method for advertising on a photographic print. The method includes a step of identifying a printer service, with the printer service providing printer services to customers, and each customer providing the printer service with image data for the printer service to print photographic prints including printed images derived from the image data. The method also includes a step of providing advertising data to the printer service, with the advertising data being representative of advertising indicia. The method further includes a step of requesting the printer service to print photographic prints including printed advertising indicia. Printed images are derived from images provided by a customer to the printer service. Each photographic print includes an image section and an advertising section, and each photographic print further includes a printed advertising indicia printed within the advertising section. The printed advertising indicia is based upon the advertising data. Each photographic print further includes a printed image printed within the image section, with the printed image being based upon the image data.

This method for advertising is innovative in its coupling of advertising data with a customer's image data on a photographic print. Accordingly, the advertising method described may serve the purpose of utilizing a photographic print as an advertising medium.

According to various embodiments of the present invention, the method for advertising may have the costs associated with the printing of the photographic prints being paid for by an advertiser. The method for adverting may not have the customer of the printer service charge for the photographic prints.

According to another aspect of the present invention, there is provided a photographic print. The photographic print includes a photographic paper stock, which has an image section and an advertising section. The photographic print also includes a printed image printed within the image section. Finally, the photographic print includes a printed advertising indicia printed within the advertising section.

This photographic print is innovative in that it contains advertising data coupled with a customer's image data. Accordingly, the photographic print device may serve as an alternative advertising medium for advertisers.

In one embodiment of the present invention, the photographic print may have an image section that is non-overlapping with the advertising section. The photographic print may be on photographic paper stock that includes lining indicia, with the lining indicia being disposed between the image and the advertising sections. The lining indicia may be identified by a dashed line. The photographic print may have the advertising section that is detachable from the image section.

In a further embodiment, the photographic print may be on photographic paper stock that includes a perforation, with the perforation being disposed between the image and advertising sections. The photographic print may be on photographic paper stock that includes a crease, with the crease being disposed between the image and advertising sections. The advertising indicia may include the identification of a retailer, a product mark, a product description, or a coupon, for examples.

### BRIEF DESCRIPTION OF THE DRAWINGS

An illustrative and presently preferred embodiment of the present invention is shown in the accompanying drawings in which:

FIG. 1 is a schematic diagram illustrating interaction between an advertiser, a customer, and a printer in printing a photographic print;

FIG. 2 is a flow chart of a method for printing on a photographic print according to an aspect of the present invention;

FIG. 3 is a flow chart of a method for advertising on a photographic print according to another aspect of the present invention;

FIG. 4 is an exploded view of a first embodiment of a printer device capable of utilizing the printing and advertising methodologies in producing a photographic print, and an exploded view of a first embodiment of a photographic print;

FIG. 5 is an exploded view of a second embodiment of a printer device capable of utilizing the printing and advertising methodologies, wherein the printer device is configurable to receive the advertising data and image data via a computer network;

FIG. 6 is an exploded view of a third embodiment of a printer device, wherein the image data storage and advertising data storage are included in a single storage device;

FIG. 7 is an exploded view of a fourth embodiment of a printer device, wherein the image data storage, advertising data storage, and coupled data storage are included in a single storage device;

FIG. 8 is an exploded view of a second embodiment of the photographic print, wherein the image section is non-overlapping with the advertising section;

FIG. 9 is an exploded view of a third embodiment of the photographic print, wherein the lining indicia is a dashed line;

FIG. 10 is an exploded view of a fourth embodiment of the photographic print, wherein the advertising section is detachable from the image section;

FIG. 11 is an exploded view of a fifth embodiment of the photographic print, wherein the photographic paper stock includes a perforation; and

FIG. 12 is an exploded view of a sixth embodiment of the photographic print, wherein the photographic paper stock includes a crease.

### DETAILED DESCRIPTION

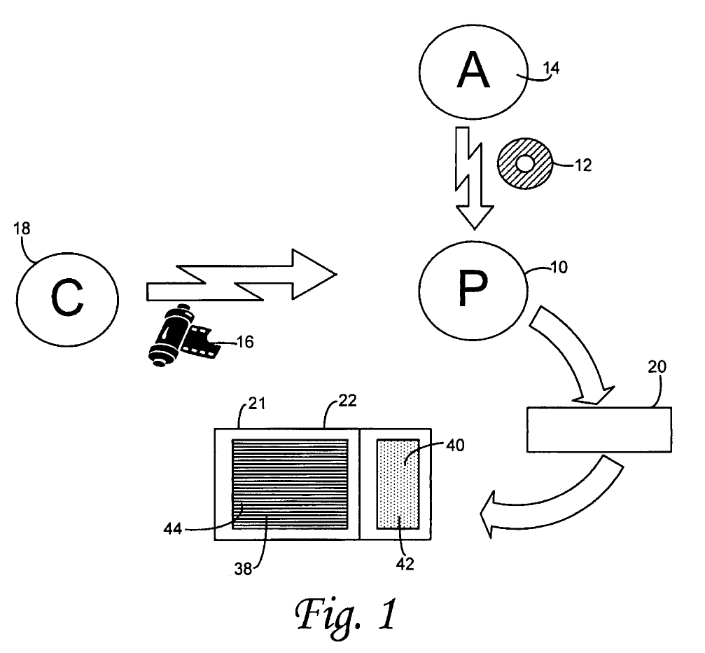

The drawings referred to herein are for the purposes of illustrating the preferred embodiments of the present invention and not for the purposes of limiting the same. FIG. 1 is a schematic view of a printing process. In this regard, a customer 18 provides image data 16 to a printer service 10. An advertiser 14 provides advertising data 12 to the printer service 10. As will be discussed in detail below, the end product of this process is a photographic print 22 which includes a printed image 44 coupled with printed advertising indicia 42. The printed advertising indicia 42 may include a variety of content which may include, but not be limited to, the identification of a retailer, a product mark, a product description, or an advertising coupon, for examples. As will be demonstrated below, by this method, the printer service 10 is potentially able to pass on substantial cost savings to the customer 18 by shifting cost burdens to the advertiser 14. The advertiser 14 is contemplated to benefit from the coupling of advertising data 12 and image data 16 into the photographic print 22 as the customer 18 and anyone else viewing the photographic print 22 is exposed to the advertiser's printed advertising indicia 42.

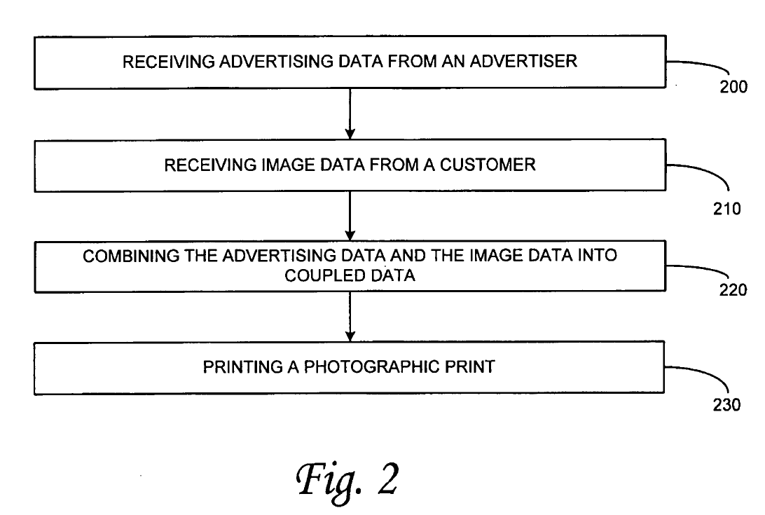

Referring now to FIG. 2, there is depicted a flow diagram indicating steps of a method for printing on the photographic print 22. In this regard, this methodology is from the perspective of the printer service 10. According to an aspect of the present invention, the method begins with an initial step 200 of the printer service 10 receiving advertising data 12 from the advertiser 14. The method further includes a step 210 of the printer service 10 receiving image data 16 from the customer 18. The method additionally comprises a step 220 of the printer service 10 combining the advertising data 12 provided by the advertiser 14 and the image data 16 provided by the customer 18 into coupled data 32. Lastly, the printing method includes a step 230 of the printer service 10 printing a photographic print 22 on photographic paper stock 21. The photographic print 22 includes an image section 38 and an advertising section 40. The photographic print 22 further includes a printed advertising indicia 42 printed within the advertising section 40. The printed advertising indicia 42 is based upon the advertising data 12 found in the coupled data 32. The photographic print 22 further includes a printed image 44 printed within the image section 38. The printed image 44 is based upon the image data 16 found in the coupled data 32.

This printing process uniquely enables the copying of the image data 16 provided by a customer 18 with the advertising data 12 provided by the advertiser 14 to produce the printed image 44 coupled with the printed advertising indicia 42 on the photographic print 22. The printed image 44 being coupled with the printed advertising indicia 42 on the photographic print 22 ensures that the customer 18 and any of those who view the photographic print 22 are a captive audience and are exposed to the printed advertising indicia 42 derived from the advertiser 14. This in turn enables creative advertising methods whose implementation may pass on substantial cost savings to the printer service 10 and customer 18 alike. It is contemplated that the advertiser 14 would be willing to pay for the costs associated with such a unique advertising channel. This will enable the printer service 10 to benefit from the economies of scale resulting from the mass production of photographic prints 22 containing some printed advertising indicia 42 paid for by the advertiser 14 As is discussed further, the customer 18 will benefit from a multi-tiered pricing structure for photographic prints 22 which contain advertising indicia.

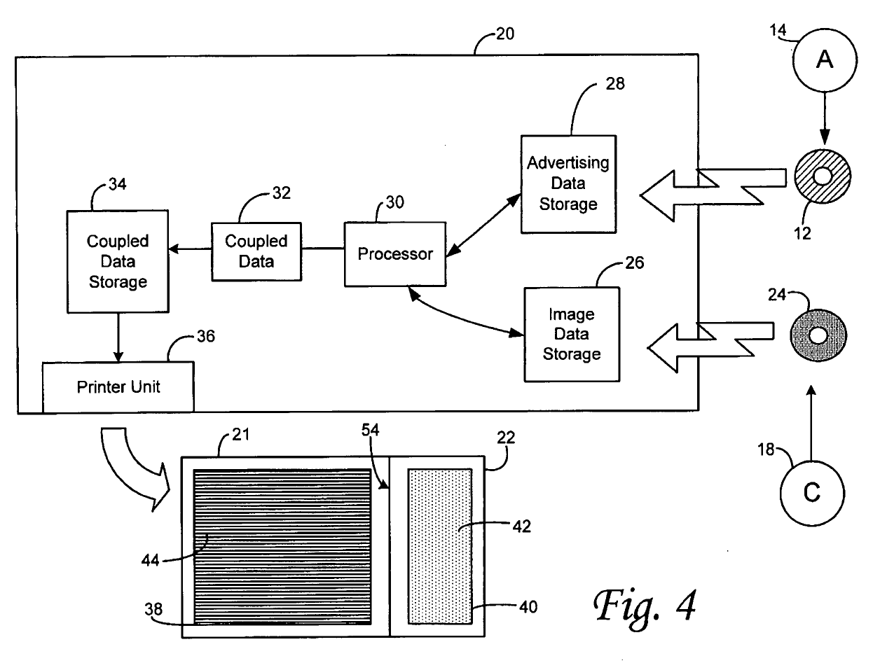

As used herein the term “image data” 16 should not be construed narrowly, but rather broadly to mean any form of image provided by the customer 18 to the printer service 10 for processing into the photographic print 22. Referring to FIG. 1, the customer 18 may provide the image data 16 to the printer service 10 for processing into the photographic print 22 in the form of a roll of film. For example, this may include 35 mm film used in many traditional cameras. Referring now to FIG. 4, the image data 16 may alternatively be already electronic image data 24. For example, the customer 18 may take photographs with a digital camera which stores the electronic image data 24 on a memory card or a data disk. The customer 18 may then provide the memory card, data disk, or any other media containing analog or digital image data 16 to the printer service 10 for processing into the photographic print 22. Thus, the image data 16 need not be limited to requiring a photography development process. The customer 18 alternatively may provide image data 16 in the form of a developed photograph or images on plain paper stock which may then be scanned by the printer service 10 into electronic image data 24.

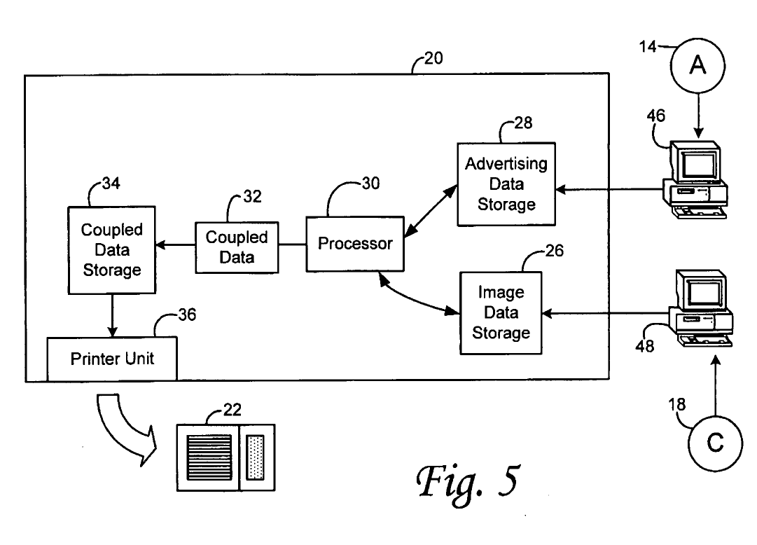

Referring now to FIG. 5, there is depicted another embodiment of the present invention which will be discussed in further detail below. In this embodiment, the customer 18 may provide the electronic image data 24 to the printer service 10 via an electronic network 48. For example, the customer 18 may convert the image taken by a digital camera into a “.jpg” format. The image data 16 may then be uploaded and sent by e-mail over the Internet to the printer service 10. As such, it is understood that the image data 16 may be provided by the customer 18 in any variety of formats and not limited to any specific physical or electronic forms.

Second, the term “advertising data” 12 should also be interpreted broadly to include any form of image provided by the advertiser 14 to the printer service 10 for processing into the photographic print 22. Referring to FIG. 1, the advertising data 12 may for example be provided by the advertiser 14 to the printer service 10 on a roll of 35 mm film for processing into the photographic print 22. Alternatively, as is also depicted in FIG. 1, the advertising data 12 may be provided by the advertiser 14 to the printer service in electronic form, such as on a memory card used in digital cameras. Referring again to FIG. 1, the advertiser 14 may provide advertising data 12 in the form of a developed photograph or other image on plain paper stock to the printer service 10 for scanning and conversion into electronic advertising data 12. Referring now to FIG. 5, the advertiser 14 may provide the advertising data 12 to the printer service 10 via an electronic network 46. For example, as with image data 24 sent over the computer network 48 by the customer 18, the advertiser 14 may send to the printer service 10 advertising data 12 taken by a digital camera in “.jpg” format over the Internet via the electronic network 46.

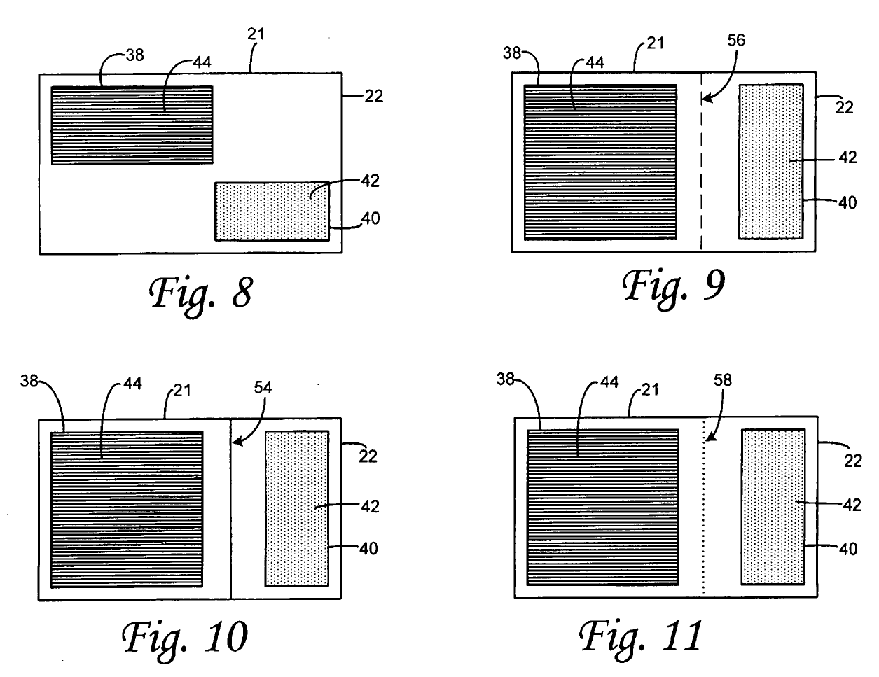

The term “photographic print” 22 should be defined to include any combination of “image data” 46 and “advertising data” 12 as defined herein, which has been processed into coupled data 32 and printed onto photographic paper stock as a printed image 44 and a printed advertising indicia 42. Examples of the manner in which a photographic print 22 is created by the innovative coupling of image data 16 and advertising data 12 is described in FIGS. 4-7, and is discussed in further detail below. The appearance of the photographic print 22, as the end product of the coupling of image data 16 and advertising data 12, is depicted in various embodiments described in FIGS. 8-12.

The term “photographic paper stock” 21 should be defined to include any type of physical object onto which the printed image 44 and printed advertising indicia 42 may be printed. The photographic paper stock 21 may include traditional photographic paper capable of undergoing chemical development processes to produce a glossy or matte photograph. The photographic paper stock 21 may also be any product whose surface is capable of absorbing an ink-based or other compound to produce an image. For example, the photographic paper stock 21 may be traditional paper, such as a 8½×11 inch sheet of paper capable of absorbing toner from a standard laser printer. The photographic paper stock 21 may also include cardboards. The photographic paper stock 21 may be formed of organic materials and inorganic materials and may be coated.

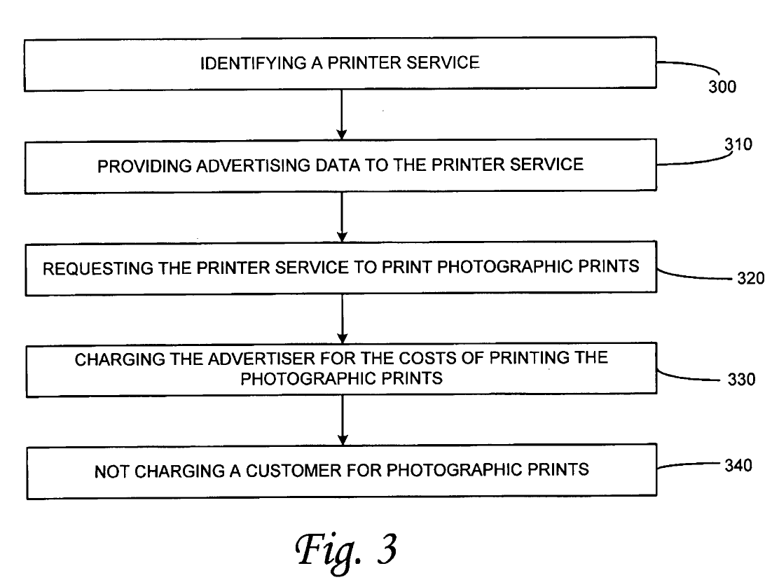

Referring now to FIG. 3, there is depicted a flow chart of aspects of the present invention. According to an aspect of the present invention, there is provided a method for advertising utilizing photographic printer services. In this regard, this aspect of the present invention is from the perspective of the advertiser 14.

Still referring to FIG. 3, the method begins with an initial step 300 of an advertiser 14 identifying a printer service 10 which provides printing services to customers 18 who wish to provide image data 16 for processing into a photographic print 22. The method further comprises a step 310 of the advertiser 14 providing advertising data 12 to the printer service 10 containing some advertising indicia 42. The method additionally comprises a step 320 of the advertiser 14 requesting the printer service 10 to print the photographic print 22, which includes the printed advertising indicia 42 in the advertising section 40 provided by the advertiser 14 coupled with the printed image 44 in an image section 38 derived from image data 16 provided by the customer 18.

Step 330 may include the printer service 10 charging the advertiser 14 for the costs of printing a photographic print 22 which incorporates the advertiser's desired printed advertising indicia 42. Step 340 may include the printer service 10 not charging the customer 18 for photographic prints 22 whose costs have been paid for by the advertiser 14 in step 330.

Referring to FIG. 1, an embodiment of the printing method may include in step 200 the printer service 10 receiving advertising data 12 from the advertiser 14 in electronic form such as in a CD-ROM format. As is depicted in FIG. 1, the advertising data 12 may be provided by the advertiser 14 on traditional film. Referring now to FIG. 5, step 200 may alternatively include the advertiser 14 providing the image data 16 to the printer service 10 via the computer network 46. Referring to FIGS. 1 and 4, step 210 may include the receipt by the printer service 10 of image data 16 from the customer 18 on film, or as electronic image data 24. Referring to FIG. 5, step 210 may additionally include the receipt by the printer service 10 of image data 16 from a customer 18 via a computer network 48.

Step 210 may also include offering to the customer 18 printer services for the processing of image data 16 at a first pricing level for the photographic print 22 which includes printed advertising indicia 42. Step 210 may further include offering to the customer 18 the printing of the photographic print 22 at a second pricing level. In this embodiment, the photographic print 22 would not include printed advertising indicia 42. As a further alternative embodiment, step 210 may include a first pricing level for the photographic print which is less than the second pricing level. This embodiment may further include an offer to the customer 18 by the printer service 10 wherein the first pricing level does not charge the customer 18 for the photographic print 22.

Step 230 of the printing method may include the printing of the photographic print 22 by the advertiser 14 rather than by a printer service 10. Step 230 may further include the charging of a fee to the advertiser 14 by the printer service 10 for the inclusion of printing advertising indicia 42 in the photographic print 22. Step 230 may further include not charging any fee to the customer 18 for the printing of a photographic print 22. Step 230 may alternatively include the charging of a fee to the advertiser 14 for the costs incurred by the printer service 10 in the printing of the photographic print 22.

This advertising method may be especially useful to an advertiser 14 of retail goods or services who elects to incorporate an in-house printer service 10. In so doing, a multi-service and product advertiser such as a large retailer may be able to implement this method by coupling the printed image 44 processed for customers 18 by the in-house printer service 10 department with printed advertising indicia 42 promoting goods or services in its other departments. For example, the advertiser 14 may create the photographic print 22 such that it includes printed advertising indicia 42 which may advertise a sale on high-definition flat screen television sets in the consumer electronics department or a sale on all-terrain tires in the automotive department. In having adopted this advertising method, the advertiser 14 is able to off-set a part of its advertising budget by the in-house printer service 10, while at the same time insuring that their advertising indicia is read by a captive audience.

Having provided the customer 18 in various embodiments with the multi-tiered pricing levels for the purchase of photographic prints 22, the customer is empowered with the freedom of choice as to whether they wish to be exposed to printed advertising indicia 42. As has been discussed herein, television viewers have restricted choices when it comes to deciding whether they wish to view commercials which interrupt their desired programming. At best, a digital video recorder or some subscription services enable television viewers to reduce their time spent viewing television commercials. However, they cannot be avoided altogether. With one embodiment of this advertising method, by providing an economic incentive to view printed advertising indicia 42, the customer 18 may be motivated to pay attention to advertising indicia which would have otherwise been ignored. Alternatively, the customer 18 may choose to pay a higher price for photographic prints 22 that do not contain advertising indicia. For example, if the printer service 10 offers a first pricing level for photographic prints 22 containing printed advertising indicia 42 which is 50% less than the second pricing level which contains no printed advertising indicia 42, the customer will clearly have an economic incentive to choose the first pricing level. Under such circumstances, the customer 18 may appreciate the fact that they are given a choice as to whether they wish to view advertising indicia. The customer 18 may be especially incentivized to view photographic prints 22 containing printed advertising indicia 42 if the first pricing level for the photographic print 22 is set at no charge to the customer 18. Depending on their preferences, the customer 18 may elect to use the printer service 10 which only offers photographic prints 22 that contain printed advertising indicia 42.

In an embodiment where the advertiser 14 has an in-house printer service 10, a multi-tiered pricing system may allow the advertiser 14 to decide which products or services it feels will be best promoted to and received by the consuming public at any given time using this advertising method. Furthermore, the advertiser 14 may be able to set their pricing structure for photographic prints 22 such that the costs of printing printed advertising indicia 42 are ultimately borne by the customer 18 who elects to purchase a photographic print 22 which contains no advertising indicia.

A first embodiment of the photographic print 22 is shown in FIG. 4. The photographic print 22 may be comprised of the image section 38, the printed image 44 within the image section 38, the advertising section 40, and the printed advertising indicia 42 in the advertising section 40. The photographic print 22 may be processed onto any photographic paper stock 21, thereby providing the advertiser 14 with unlimited options in terms of the format in which it wishes to display its advertising indicia. The printed advertising indicia 42 may for example contain the identification of a retailer, the identification of a product mark, the identification of a product description, or the inclusion of a coupon, depending on the advertising indicia the advertiser 14 desires to promote.

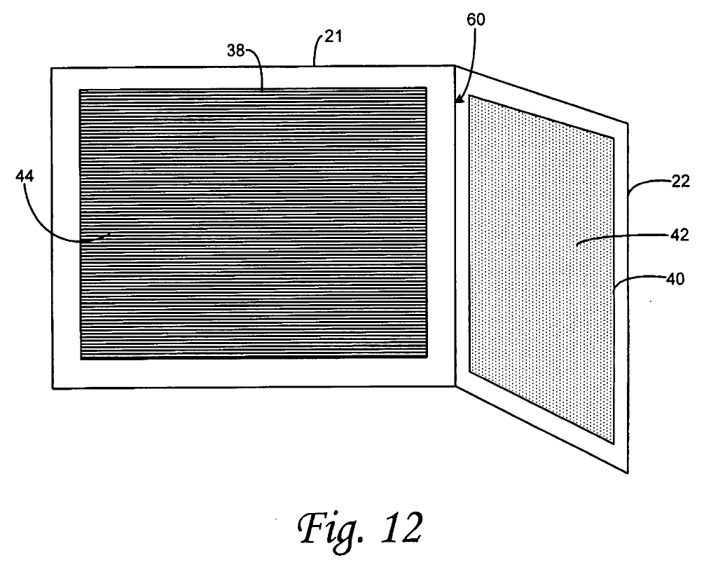

Referring now to FIG. 8, there is depicted in an alternative embodiment the image section 38 and the advertising section 40 in the photographic print 22 which do not overlap or are not otherwise contiguous with each other. Referring now to FIG. 4, the photographic paper stock 21 may also define a lining indicia 54 located between the image section 38 and advertising section 40. While FIG. 4 depicts the image section 38 and the advertising section 40 as having some additional separation from the lining indicia 54, the image section 38 and the advertising section 40 may in fact be touching or in direct contact with each other. Referring to FIG. 9, the lining indicia 54 may be characterized by a dashed line 56 located between the image section 38 and advertising section 40. In an alternative embodiment depicted in FIG. 10, the advertising section 40 may be detachable from the image section 38 at the lining indicia 54. Referring to FIG. 11, the lining indicia 54 may be defined by a perforation 58 between the image section 38 and advertising section 40 on the photographic print 22. In yet another embodiment depicted in FIG. 12, the lining indicia 54 may be defined by a crease 60 between the image section 38 and advertising section 40.

This photographic print 22 may be particularly well adapted to appealing to the customer 18. The embodiment enabling the printed advertising indicia 42 to be detached from the printed image 44 uniquely incentivizes the customer 18 to elect to purchase the photographic print 22 which includes some advertising indicia. This is due to the simple manner in which the customer 18 may remove or detach the printed advertising indicia 42 from the printed image 44. As has been discussed above, the customer 18 is more likely to be a captive audience of advertising if they know that they have the freedom to choose whether to view or not view the advertising indicia. By example, if the customer 18 knows that the time spent viewing advertising indicia on a photographic print 22 may be mitigated by the simple step of removing it from the printed image 44, the customer 18 is far more likely to be accepting of this form of advertising. Should the content of the printed advertising indicia 42 be of interest to the customer 18, such as when the printed advertising indicia 42 is a discount coupon or promotion for a desired good or service, the customer 18 will be encouraged to detach the printed advertising indicia 42 and keep it for future use.

Various embodiments of a printer device 20 capable of utilizing the printing and advertising methodologies in producing a photographic print 22 are shown in FIGS. 4, 5, 6, and 7. Referring to FIG. 4, the printer device 20 may comprise an image data storage 26, an advertising data storage 28, and a processor 30 configured to combine image data 16 or electronic image data 24 from the image data storage 26 and advertising data 12 from the advertising data storage 28 to form coupled data 32. Still referring to FIG. 4, the printer device 20 may further comprise a coupled data storage 34 for the storage of the coupled data 32, and a printer unit 36 to print the photographic print 22 derived from the information contained in the coupled data storage 34. The coupled data storage 34 may store coupled data 32 as a designated computer file or in the computer's Random Access Memory (RAM). It is contemplated that in one embodiment of a printer device 20 implementing the printing and advertising methodologies, the coupled data 32 may be stored in the coupled data storage 34 available in a computer's long-term memory. Upon initiation of the printing process, the coupled data 32 stored in such long-term memory may be uploaded to the computer's RAM for printing the photographic print 22 by the printer device 20. In another embodiment of a printer device 20, the coupled data storage 34 containing coupled data 32 may already exist in RAM, thus bypassing the transferring of information from the computer's long-term memory. Under either embodiment, the printer unit 36 then prints the photographic print 22, which includes the image section 38 containing the printed image 44 and the advertising section 40 containing the printed advertising indicia 42. By example, the Noritsu QSS 3001 digital minilab printer is capable of storing coupled data 32 in a computer's long-term memory or in RAM in implementing these methodologies to print a photographic print 22.

Referring to FIGS. 1, 4, and 5, a printer device 20 utilizing the printing and advertising methodologies may optionally be configured to receive advertising data 12 from the advertiser 14 electronically, on film, or via an electronic network 46. In other embodiments also depicted in FIGS. 1, 4, and 5, a printer device 20 may be configured to receive image data 16 from the customer 18 on film, as electronic image data 24, or via an electronic network 48.

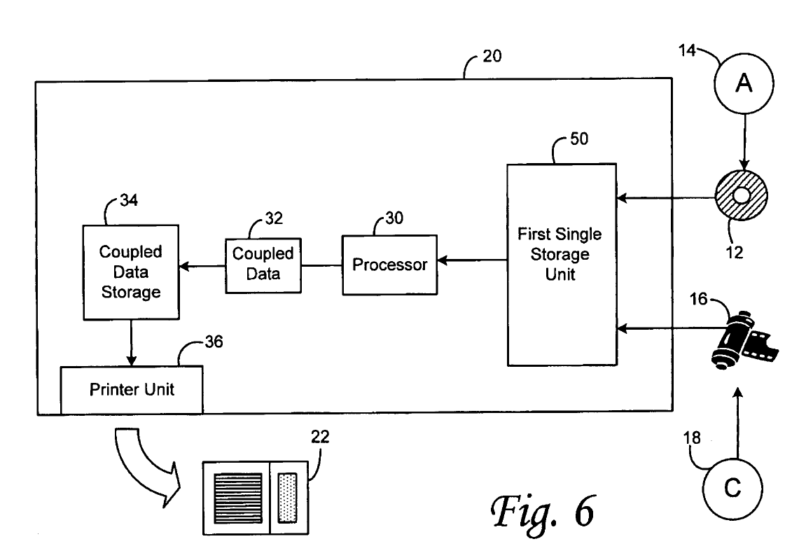

Referring to FIG. 6, in another embodiment of a printer device 20, the image data storage 26 and the advertising data storage 28 are contained in a first single storage unit 50.

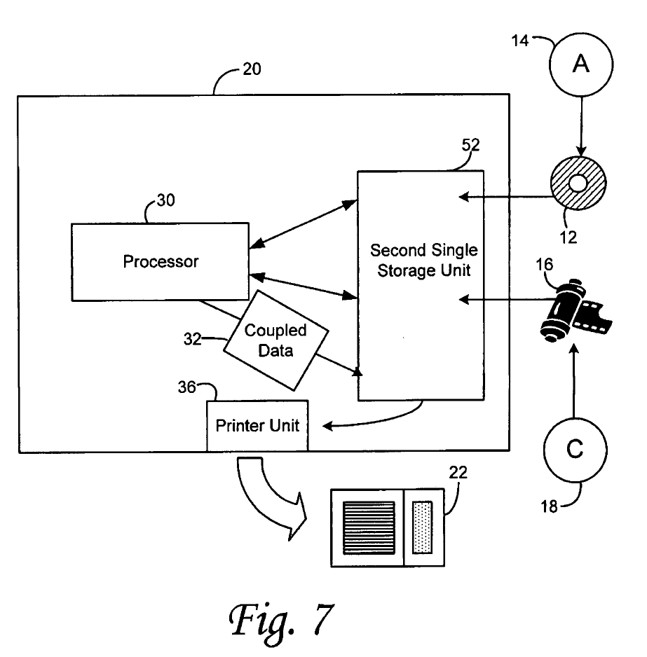

Referring now to FIG. 7, in yet another embodiment of a printer device 20 utilizing the printing and advertising methodologies, the image data storage 26, the advertising data storage 28, and the coupled data storage 34 may all be contained in a second single storage unit 52.

This printer device 20 is uniquely equipped to receive advertising data 12 and image data 16 in all forms, thereby giving the printer service 10, the advertiser 14, and the customer 18 a flexibility and ease of use. In various embodiments, the storage of information received from the advertiser 14 and the customer 18 into a first single storage unit 50 or second single storage unit 52 allows for the efficient transfer of information during the process of coupling the printed advertising indicia 42 with the printed image 44 and subsequent printing of the photographic print 22 by the printer unit 36.

What is claimed is:

1. A method for printing on a photographic print, the method comprising the steps of:
a) receiving advertising data from an advertiser;
b) receiving image data from a customer;
c) combining the advertising data and the image data into coupled data; and
d) printing a photographic print, the photographic print including a photographic paper stock including an image section and an advertising section, the photographic print further including a printed advertising indicia printed within the advertising section, the printed advertising indicia being based upon the advertising data found in the coupled data, the photographic print further including a printed image printed within the image section, the printed image being based upon the image data found in the coupled data.

2. The method for printing as claimed in claim 1, wherein the advertiser prints the photographic print.

3. The method for printing as claimed in claim 1, wherein the advertiser does not print the photographic print.

4. The method for printing as claimed in claim 1, wherein the advertising data is received in electronic form.

5. The method for printing as claimed in claim 1, wherein the image data is received in the form of negatives.

6. The method for printing as claimed in claim 1, wherein the image data is received in electronic form.

7. The method for printing as claimed in claim 6, wherein the image data is received via a computer network.

8. The method for printing as claimed in claim 1, wherein the method further includes a step of charging a fee to the advertiser for inclusion of the printed advertising indicia in the photographic print.

9. The method for printing as claimed in claim 8, wherein costs associated with the printing of the photographic print are paid for by the advertiser.

10. The method for printing as claimed in claim 8, wherein the customer is not charged for the photographic print.

11. The method for printing as claimed in claim 1, wherein the printing of the photographic print is at no charge to the customer.

12. The method for printing in claim 1, wherein prior to step c) the method further comprising the step of:
offering to the customer printing services of the image data with a first pricing level for printing including printed advertising indicia and a second pricing level for printing not including printed advertising indicia.

13. The method for printing in claim 12, wherein the first pricing level is less than the second pricing level.

14. The method for printing in claim 13, wherein the first pricing level is at no charge.

15. The method for printing as claimed in claim 1, wherein the coupled data is in Random Access Memory (RAM).

16. A method for advertising on a photographic print, the method comprising the steps of:
a) identifying a printer service, the printer service providing printing services to customers, each customer providing the printer service with image data for the printer service to print photographic prints including printed images derived from the image data;
b) providing advertising data to the printer service, the advertising data being representative of advertising indicia; and
c) requesting the printer service to print photographic prints including printed advertising indicia with printed images derived from images provided by a customer of the printer service, each photographic print including an image section and an advertising section, each photographic print further including a printed advertising indicia printed within the advertising section, the printed advertising indicia being based upon the advertising data, each photographic print further including a printed image printed within the image section, the printed image being based upon the image data.

17. The method for advertising as claimed in claim 16, wherein costs associated with the printing of the photographic prints are paid for by an advertiser.

18. The method for printing as claimed in claim 17, wherein a customer of the printer service is not charged for the photographic prints.

19. A photographic print comprising:
a photographic paper stock, including an image section and an advertising section;
a printed image printed within the image section; and
a printed advertising indicia printed within the advertising section.

20. The photographic print as claimed in claim 19, wherein the image section is non-overlapping with the advertising section.

21. The photographic print as claimed in claim 19, wherein the photographic paper stock includes lining indicia, the lining indicia being disposed between the image and the advertising sections;

22. The photographic print as claimed in claim 21, wherein the lining indicia is a dashed line.

23. The photographic print as claimed in claim 19, wherein the advertising section is detachable from the image section.

24. The photographic print as claimed in claim 19, wherein the photographic paper stock includes a perforation, the perforation being disposed between the image and advertising sections.

25. The photographic print as claimed in claim 19, wherein the photographic paper stock includes a crease, the crease being disposed between the image and advertising sections.

26. The photographic print as claimed in claim 19, wherein the advertising indicia includes identification of a retailer.

27. The photographic print as claimed in claim 19, wherein the advertising indicia includes a product mark.

28. The photographic print as claimed in claim 19, wherein the advertising indicia includes a product description.

29. The photographic print as claimed in claim 19, wherein the advertising indicia includes a coupon.
